(19) United States
(12) Patent Application Publication
(10) Pub. No.: US 2026/0046035 A1
(43) Pub. Date: Feb. 12, 2026

(54) WIRED LIGHT FIDELITY FOR UNDERWATER COMMUNICATION

(71) Applicant: Dell Products, L.P., Round Rock, TX (US)

(72) Inventors: Shree Rathinasamy, Georgetown, TX (US); Maxim Balin, Gan-Yavne (IL)

(21) Appl. No.: 18/798,142

(22) Filed: Aug. 8, 2024

(51) Int. Cl. H04B 10/80; G02B 6/032; G02B 6/44; H04B 10/50; H04B 10/60

(52) U.S. Cl. CPC H04B 10/80; G02B 6/032; G02B 6/4427; H04B 10/502; H04B 10/60; G02B 2006/0325

(57) ABSTRACT

The described technology facilitates improved communication that can be well-suited for communication in an underwater environment. For example, the concept of wired LIFI (w-LIFI) is introduced. A conduit or cable can have a core layer composed of air (e.g., any gas or gas mixture) that, along with a cladding layer comprising a highly reflective material, operates as a medium for EM signals. Thus, over-the-air wireless communication techniques, such as LIFI, can be adapted for wired transmission. The associated w-LIFI cable is lighter in weight and/or cheaper to produce, install, maintain or repair, and operate in comparison to systems that rely on fiber optic cable, which typically has a solid core of highly refined glass fibers that are heavy and fragile.

### BACKGROUND

Underwater edge devices are becoming increasingly important for industries, such as oil and gas or other industries. Today, huge volumes of data are being generated in underwater environments, especially in remote sea or ocean locations that exhibit frequent extreme weather phenomena. Potential communication issues under these harsh conditions are further compounded as the amount of data generated increases rapidly and the speed of a communication network operating in such conditions is expected to be able to scale to support the rapid explosion of data. Currently, underwater communication is predominantly handled with fiber optic cables. In many locations, there are usually miles of fiber optic cabling and associated elements running underwater and gathering information from thousands of sensors and other devices.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts an example schematic block diagram illustrating various communication solutions for communicating data in an underwater environment in accordance with certain embodiments of this disclosure;

FIG. 2 depicts an example schematic block diagram illustrating an example deployment and implementation of a w-LIFI system in an underwater environment in accordance with certain embodiments of this disclosure;

FIG. 3 depicts an example diagram illustrating a cross-section view showing example structure of w-LIFI cable 202 in accordance with certain embodiments of this disclosure;

FIG. 4 depicts an example diagram illustrating a cross-section view an example connector for the w-LIFI cable in accordance with certain embodiments of this disclosure;

FIG. 5 depicts an example schematic block diagram illustrating an example device that can communicate according to a wired LIFI technique in accordance with certain embodiments of this disclosure;

FIG. 6 depicts an example schematic block diagram illustrating additional aspects or elements of the example device that can communicate according to a wired LIFI technique in accordance with certain embodiments of this disclosure;

FIG. 7 illustrates an example method that can provide communication between two endpoint devices according to a wired LIFI technique in accordance with certain embodiments of this disclosure;

FIG. 8 illustrates an example method that can provide for additional elements or functionality relating to communication between two endpoint devices according to a wired LIFI technique in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

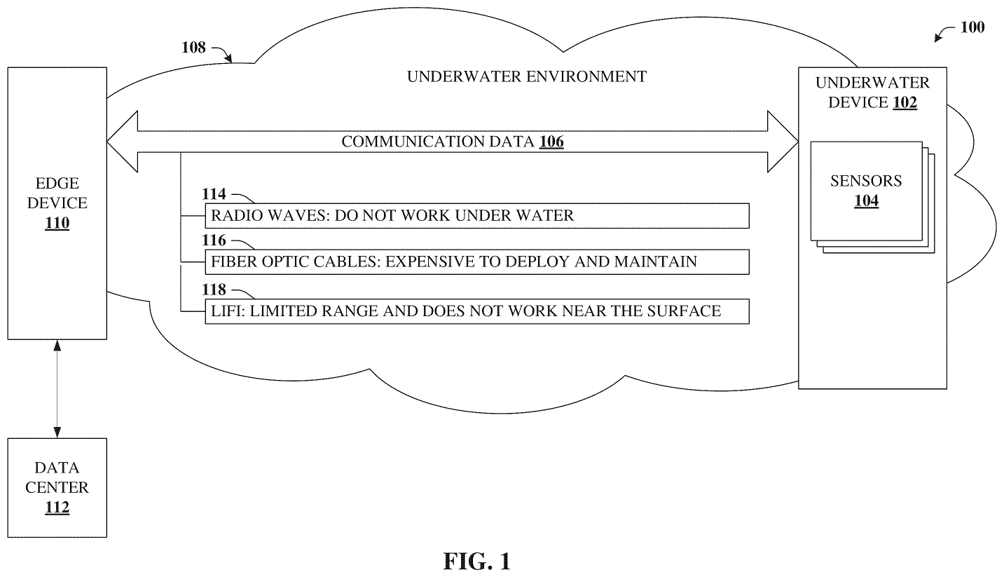

To provide additional context, consider FIG. 1. FIG. 1 shows an example schematic block diagram 100 illustrating various communication solutions for communicating data in an underwater environment 108 in accordance with certain embodiments of this disclosure.

For example, an underwater device 102 can comprise one or more sensors 104 that collect data. This data can be transmitted to other devices, such as edge device 110, which can forward the data to data center 112 or to another location where the data can be processed and analyzed. Further, control or configuration signals can be transmitted to underwater device 102. Collectively, the data collected by underwater device 102 and any information received by underwater device 102 can be referred to as communication data 106.

As illustrated, all or a portion of communication data 106 traverses underwater environment 108. It is to be appreciated that while operating in a data center 112 environment provides an administrator with a huge level of control, the offshore edge environments (e.g., underwater environment 108) are extremely chaotic and typically in remote locations. The harsh operating environment leads to issues that occur with corrosion due to seawater, turbulent weather, an increase of pressure with ocean depth, and so on.

Unfortunately, as illustrated at reference numeral 114, radio waves, including wireless fidelity (WIFI), do not work under water. Generally, radio waves are classified as electromagnetic (EM) radiation having a wavelength greater that microwaves, usually greater than a few centimeters in length and potentially going as high as kilometers in length. As a result, most underwater communication is handled by fiber optic cables that are specifically designed to withstand underwater environment 108 (e.g., submarine fiber optic cabling).

As indicated at reference numeral 116, fiber optic communication is expensive in many respects. Due in part to the expense of fiber optic cabling, alternatives are being considered, such as light fidelity (LIFI) communication techniques, which is remarkably inexpensive by comparison. However, as indicated at reference numeral 118 and further detailed below, LIFI communication has various limitations.

With regard to fiber optic solutions, communication relies on highly sophisticated transmitter and receiver sub assemblies and laser equipment that is extremely expensive. By contrast, transmitter and receiver modules for LIFI communication primarily relies on light emitted diode (LED) and photodetectors, respectively, which are extremely cheap in comparison to the laser equipment used for fiber optics communication.

Moreover, submarine fiber optic cabling suited for underwater environment 108 has a thick, flexible outer jacket and a high radius of strength members to protect the internal components. The core of fiber optic cables is comprised of solid glass or plastic. The solid fibers in the core are made of highly refined glass or plastic and are delicate. As pressure (e.g., hydrostatic pressure) increases by about 1.4 pound per square inch (psi) per meter below the surface, submarine fiber optic cabling becomes expensive and heavy. This is due to the solid core and the strength members that increase in response to increases in depth below the surface.

Therefore, installation of submarine fiber optic cable typically implicates large manned marine vessels with sophisticated equipment and know-how in order to maneuver and install the cabling, which by itself can cost millions of dollars for a single installation contract. Maintenance and repair operations can be similar in terms of expense. Furthermore, these large-scale operations to install or repair submarine fiber optic cable can have a deleterious effect on marine life and ecosystems. Hence, installation as well as the regular maintenance and repair of the fiber optic cables that arise under the ocean is expensive in general and, as a result of potentially running for hundreds of nautical miles, can pose enormous capital expenses and operational expenses, and environmental challenges.

In contrast, LIFI communication has much more inexpensive transmitter and receiver equipment (e.g., LED lamps and photodetector arrays, respectively) and does not use cabling. Rather, LIFI communication relates to a technology that utilizes light, typically in the visible spectrum (e.g., wavelengths from about 380 nanometers (nm) to about 780 nm) to transmit data. LIFI communication is a bidirectional system that transmits data via light generated by LED devices and received by photodetector devices. Unlike WIFI, which uses radio frequency, LIFI technology only uses a light source with a chip to transmit a signal via modulation of light waves.

While LIFI is typically thought of as being an over-the-air (OTA) approach, in which the medium for the light signals is air, recent experiments have been successful in using LIFI communication under the ocean, that is, relying on ocean water as the medium for transmission of the light signals. The experiment successfully communicated information at a depth of about 6000 meters over distances up to 50 meters.

At shallower depths, however, such as at typical locations for an underwater edge device, LIFI communication is generally unsuccessful, at least in part due to the presence of interference from sun light, climatic conditions, environmental disturbances, marine life, and so forth. Thus, as indicated at reference numeral 118, LIFI communication is limited in range and location. For example, conventional LIFI communication may only be feasible at great depths and over short distances, and generally at locations where the presence of sunlight and organic or inorganic particulates is limited, and, as such, can affect the properties of light propagation.

Due to the many challenges that confront wireless approaches (e.g., LIFI), most implemented network connections today are accomplished using wired solutions, namely fiber optic cabling, despite the extraordinary expense.

In order to address these and other challenges, the disclosed subject matter proposes wired LIFI (w-LIFI), which can capture certain advantages associated with both ordinary wireless LIFI (e.g., reduced costs) and fiber optics approaches (e.g., greater transmission distances and range of application), while avoiding certain associated limitations.

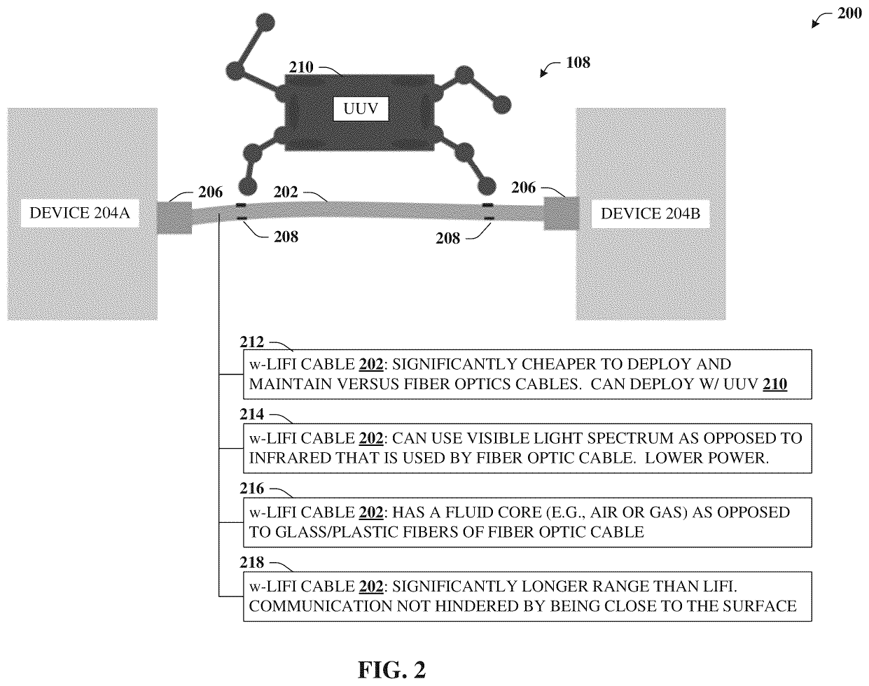

In that regard, the disclosed subject matter for LIFI can leverage communication techniques, protocols, or standards for encoding light signals, but rather than transmitting those signals OTA and/or over (via) a water medium, the light signals can be transmitted according to a wired implementation, over (via) a lightguide wire or cable, which can be referred to herein as a w-LIFI cable or the like, and which is further detailed in connection with FIG. 2 and subsequent drawings.

### Example Systems

With reference to FIG. 2, an example schematic block diagram 200 is depicted illustrating an example deployment and implementation of a w-LIFI system in a submarine and/or an underwater environment in accordance with certain embodiments of this disclosure.

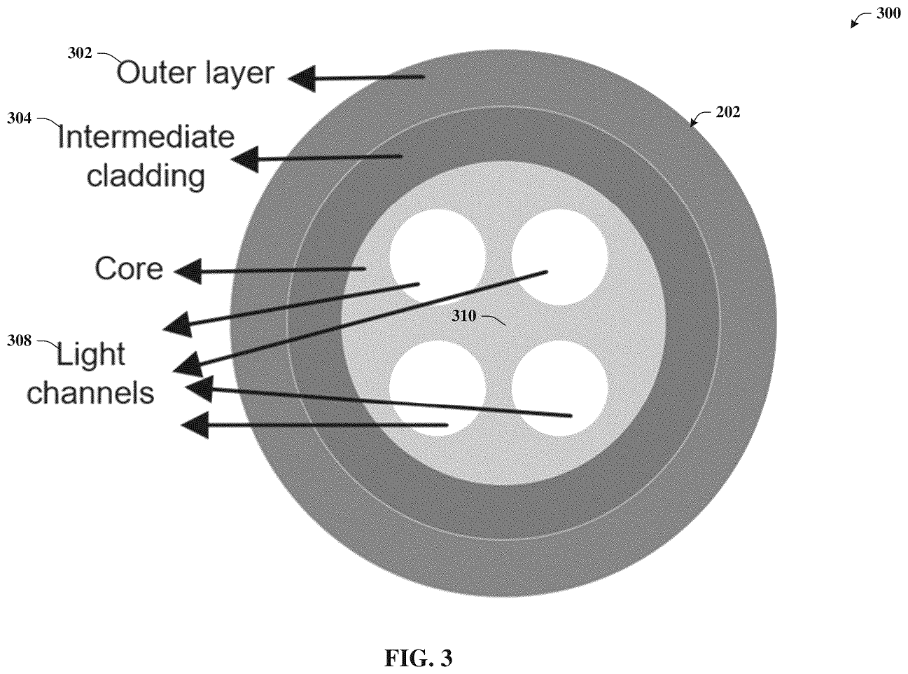

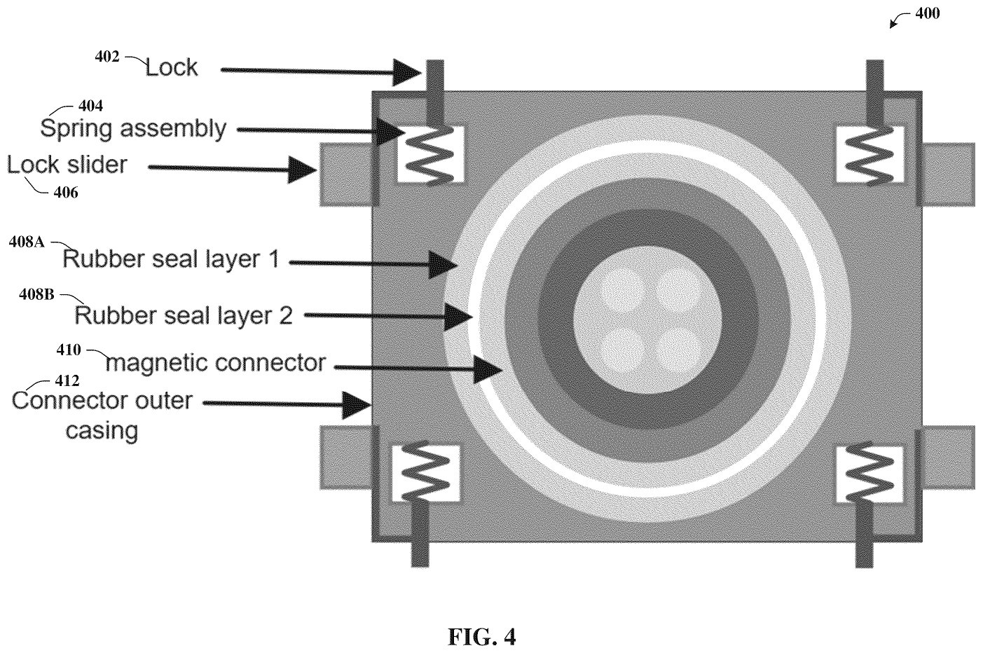

As illustrated, a lightguide cable, also referred to herein as w-LIFI cable 202, can be installed in underwater environment 108. As will be further detailed with reference to FIGS. 3 and 4, and indicated here at reference numeral 216, w-LIFI cable 202 can comprise the medium (e.g., air or another fluid) that is used to carry LIFI signals. Such can be contrasted with conventional fiber optic cables, which comprise a solid core (e.g., glass or plastic fibers). Further, unlike conventional wireless LIFI, which suffers extensively due to interference and other disruptions, because the medium at the core of w-LIFI cable 202 is contained within the w-LIFI cable 202, interference from other light sources (e.g., the sun) or other disruptions from particulates, debris, or organic life, such as phytoplankton, zooplankton, fish, aquatic plants, and so forth can be avoided.

As illustrated at reference numeral 212, unlike conventional fiber optic solutions, w-LIFI cable 202 is relatively lightweight and can be installed and maintained using a submarine drone and/or an underwater unmanned vehicle (UUV) 210. Using UUV 210 for installation or maintenance can reduce installation, maintenance, or other costs by an order of magnitude or more.

In that regard, w-LIFI cable 202 can comprise a specialized connector (e.g., connector 206) that can simplify or streamline coupling operations that attach w-LIFI cable 202 to network devices 204, illustrated here as device 204A and 204B. Connector 206 can be configured to provide simplified or streamlined connection for UUV 210. Network devices 204 can be an edge device 110, underwater device 102, sensor 104, as detailed in connection with FIG. 1, or another suitable device.

Furthermore, w-LIFI cable 202 can comprise a sealing device 208 or mechanism situated at opposing ends of w-LIFI cable 202. During installation, the sealing device 208 can be closed to prevent water from entering w-LIFI cable 202 and/or the fluid medium from escaping. After coupling connector 206 to a device 204, the associated sealing mechanism can be opened to expose the core to device 204. Sealing device 208 can be configured for simplified or streamlined manipulation by UUV 210. Additional detail relating to connector 206 and sealing device 208 can be found with reference to FIG. 4.

As indicated at reference numeral 214, w-LIFI cable 202 can use light signals in the visible spectrum, such as light having a wavelength of between about 380 nm to about 780 nm. Such can be produced by inexpensive LED devices and can be further contrasted with fiber optic cables, which are designed to propagate light in the infrared spectrum. For example, the comparatively more expensive lasers of a fiber optic communication system are generally configured to produce signals having a wavelength of 850 nm, 1300 nm, or 1550 nm, all of which are in the infrared spectrum. In fiber optic solutions, these wavelengths are specifically chosen because those wavelengths are determined to have the least loss when transmitted through the optical fibers.

Furthermore, as indicated at reference numeral 218, communication via w-LIFI cable 202 can have significantly longer range in underwater environment 108 than an associated communication of a LIFI implementation. Moreover, communication via w-LIFI cable 202 is not hindered by proximity to the surface as is the case with LIFI and thus has a much broader range of applications versus underwater LIFI solutions.

Turning now to FIG. 3, an example diagram 300 is depicted illustrating a cross-section view showing example structure of w-LIFI cable 202 in accordance with certain embodiments of this disclosure. As illustrated, w-LIFI cable 202 can comprise outer layer 302. Outer layer 302 can comprise, or be comprised of, a first material that is flexible according to a flexibility criterion, resists corrosion when immersed in water with respect to a non-corrosion criterion, and is configured to withstand a hydrostatic pressure above a defined threshold. In other words, outer layer 302 can be composed of a flexible, non-corrosive material that can withstand the extremities of underwater environment 108, particularly in saltwater environments. In some embodiments, outer layer 302 and/or the first material can be a composite plastic material.

Furthermore, w-LIFI cable 202 can comprise intermediate cladding layer 304. In some embodiments, intermediate cladding layer 304 can be configured to clad core 306. In some embodiments, intermediate cladding layer 304 can comprise, or be comprised of, a second material configured to clad a reflective material to an inner surface of outer layer 302. In some embodiments, the reflective material can be a dielectric mirror coating. In reflectivity studies, composite plastics (e.g., the first material of the outer layer 302) with a dielectric mirror coating (e.g., intermediate cladding layer 304) have been shown to be capable of reflecting of up to 99% or more of incident light signals.

Continuing, w-LIFI cable 202 can comprise core layer 306. Core layer 306 can comprise or can be composed of a fluid 310. In some embodiments, fluid 310 can be air or another material or composition having a gaseous and/or non-solid state of matter. In popular vernacular, ‘air’ is widely considered to represent a colorless, odorless gas that surrounds the Earth. However, as used herein, ‘air’ is intended to include any gas or gas mixture, including gases that may have a visible color or detectable odor and not limited to the mixture that is in the ambient air or atmosphere of Earth.

As noted, w-LIFI cable 202 can operate as an underwater transport medium for EM and/or electromagnetic radiation (EMR) signals. In that regard, fluid 310, residing in core layer 306 can operate as the propagation medium for the EMR signals that are propagated from a first end of w-LIFI cable 202 (e.g., from device 204A) through fluid 310 to a second end of w-LIFI cable 202 (e.g., to device 204B) via interactions with the reflective material.

As illustrated, fluid 310 can provide one or more light channels 308, which can be utilized by an associated LED device. As shown here, there are four distinct light channels 308, which implies four different LED devices, but it is appreciated that any suitable number of light channels can exist, which can be more than four or fewer than four.

Referring now to FIG. 4, an example diagram 400 is depicted illustrating a cross-section view of an example connector 400 for the w-LIFI cable 202 in accordance with certain embodiments of this disclosure. For example, w-LIFI cable 202 can comprise a specialized connector 400 (e.g., connector 206) at opposing ends. Connector 400 can be configured to allow easy alignment and connection with devices 204, which can be beneficial during installation via UUV 210. Connector 400 can comprise a lock mechanism 402 that can be configured to lock the connector 400 in place after a mating procedure. Lock 402 can comprise spring assembly 404 to provide tension and lock slider 406.

Connector 400 can further comprise rubber seals 408. In this example, two rubber seals 408A and 408B are depicted but it is appreciated that any suitable number of rubber seals 408 can be used. Moreover, connector 400 can comprise magnetic connector 410. As illustrated, both rubber seals 408 can magnetic connector 410 can have a ring shape. Magnetic connector 410 can comprise relatively powerful magnet, such as a neodymium (NdFeB) magnet. Also illustrated is connector outer casing 412.

Connector 400 can mate with corresponding connectors on devices 204, which can have similar magnetic design as well as non-corrosive metal rings that allow w-LIFI cable 202 to align seamlessly before the connectors mate and engage. The connectors can be constructed to provide water-sealing mating and to prevent water from entering w-LIFI cable 202 once the sealing devices 208 are opened.

Sealing devices 208 can be configured to be manipulated by UUV 210 in order to change the state (e.g., open or closed). Such an implementation can be achieved through the use of a closing mechanism or switch coupled to a level situated on the exterior surface of w-LIFI cable 202. For instance, UUV 210 can have improved control over the opening and shutting of the seals by manipulating the lever. The actual seals can be any suitable form, such as, e.g., an aperture shutter seal or the like.

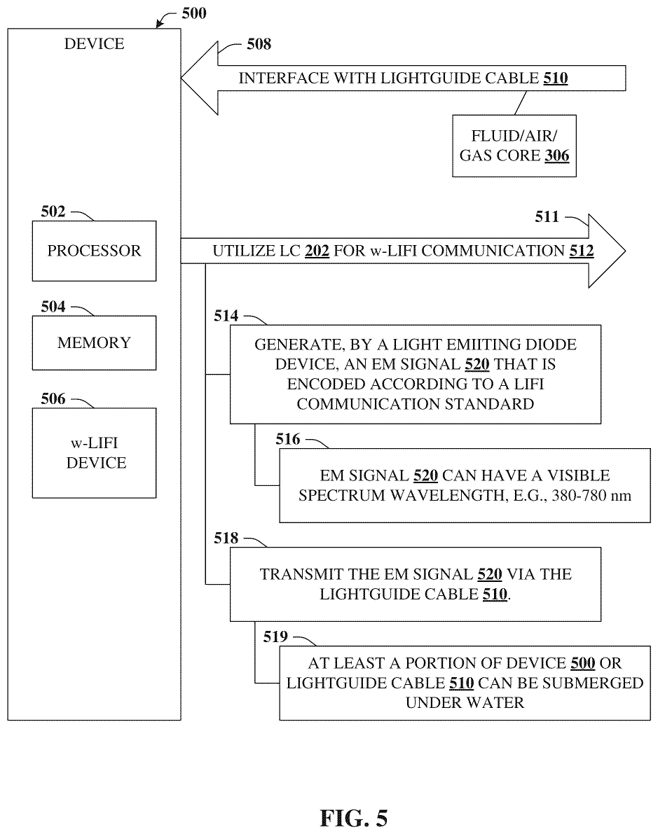

With reference now to FIG. 5, an example schematic block diagram illustrating an example device 500 that can communicate according to a wired LIFI technique in accordance with certain embodiments of this disclosure. In some embodiments, all or a portion of device 500 can be included in an underwater device, such as an underwater edge device (e.g., edge device 110 of FIG. 1), an underwater device 102 having sensors 104 that collect data, and/or device 204 of FIG. 2.

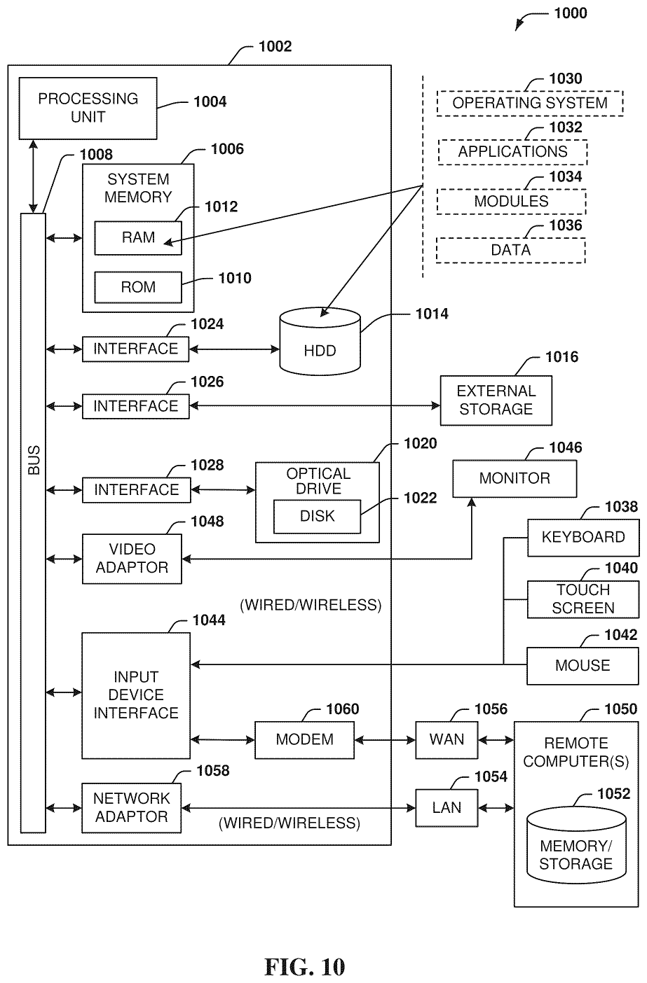

Device 500 can comprise at least one processor 502 that, potentially along with temporal w-LIFI device 506 (e.g., all or a portion of device 204), can be specifically configured to perform functions associated with implementing techniques associated with wired light fidelity communication. Device 500 can also comprise at least one memory 504 that stores executable instructions that, when executed by the at least one processor 502, can facilitate performance of operations. Processor(s) 502 can be a hardware processor having structural elements known to exist in connection with processing units or circuits, with various operations of processor 502 being represented by functional elements shown in the drawings herein that can require special-purpose instructions, for example, stored in memory 504 and/or temporal w-LIFI device 506. Along with these special-purpose instructions, processor 502 and/or temporal w-LIFI device 506 can be a special-purpose device. Further examples of the memory 504 and processor 502 can be found with reference to FIG. 10. It is to be appreciated that device 500 or computer 1002 can represent a server device or a client device of a network or data services platform and computer 1002 can be used in connection with implementing one or more of the systems, devices, or components shown and described in connection with FIG. 5 and other figures disclosed herein.

As illustrated at reference numeral 508, device 500 can interface lightguide cable 510 (e.g., w-LIFI cable 202). Lightguide cable 510 can be configured to have a core layer comprising a fluid (e.g., air or gas) that is configured to transport electromagnetic signals through lightguide cable 510. An example of a fluid core layer can be found with respect to core layer 306 of FIG. 3.

At reference numeral 511, device 500 can utilize lightguide cable 510 for communicating according to a wired light fidelity (w-LIFI) communication 512 technique. For example, as indicated at reference numeral 514, device 500 can comprise a transmitter module or unit having one or many LED devices (e.g., single channel or multichannel). The LED devices can generate an EM signal 520 that can be encoded according to a LIFI communication technique, protocol, or standard. As indicated at reference numeral 516, EM signal 520 can have a visible spectrum wavelength, such as a wavelength of between a range of about 380 nm to about 780 nm.

At reference numeral 518, the device can transmit EM signal 520 via lightguide cable 510. As indicated at reference numeral 519, at least a portion of device 500 or lightguide cable 510 can be submerged under water. Hence, even though EM signal 520 traverses, in whole or in part, underwater environment 108, the deleterious effects of underwater environment 108 do not affect EM signal 520, as is the case for ordinary (wireless) LIFI. Rather, EM signal 520 can be propagated by lightguide cable 510, rather than by ambient water that can cause undesirable interference with, and degradation of, LIFI signals.

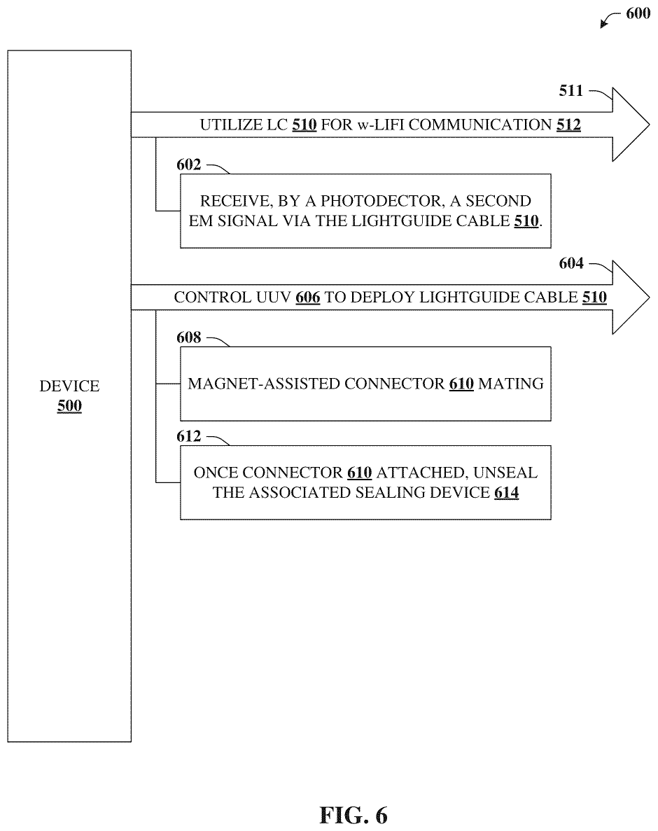

With reference now to FIG. 6, an example schematic block diagram 600 illustrating additional aspects or elements of the example device 500 that can communicate according to a wired LIFI technique in accordance with certain embodiments of this disclosure.

As was noted in connection reference numeral 511 of FIG. 5, device 500 can utilize lightguide cable 510 for w-LIFI communication 512, comprising transmitting EM signal 520 via lightguide cable 510. Furthermore, as shown at reference numeral 602, device 500 can receive a second EM signal 520 via the lightguide cable 510. For example, device 500 can comprise one or more receiver modules or units comprising photodetector devices or arrays. The photodetector devices can be configured to receive or detect the second EM signal 520 that is propagated via lightguide cable 510.

At reference numeral 604, device 500 can facilitate (potentially in combination with control device) control of UUV 606. UUV 606 can be employed to deploy lightguide cable 510. It is noted that due to the greater weight associated with fiber optic cable solutions, UUV 606 is not feasible for installation procedures. Hence, leveraging UUV 606 for installation can result in an increased cost saving for installation and maintenance operations.

At reference 608, the installation operation can comprise magnet-assisted connector 610 mating. An example of a connector that can be used is provided at FIG. 4, showing a magnet connector 410 portion. For instance, the magnet can be a high-powered magnet, such as a neodymium (NdFeB) magnet. Such can aid UUV 606 in aligning connector 610 during the mating procedure.

As indicated at reference numeral 612, once connector 610 has been attached to as associated communication device (e.g., device 500, device 204, edge device 110, . . . ), UUV 610 can be controlled to unseal the associated sealing device 614. An example of sealing device 614 can be sealing device 208 of FIG. 2.

### Example Methods

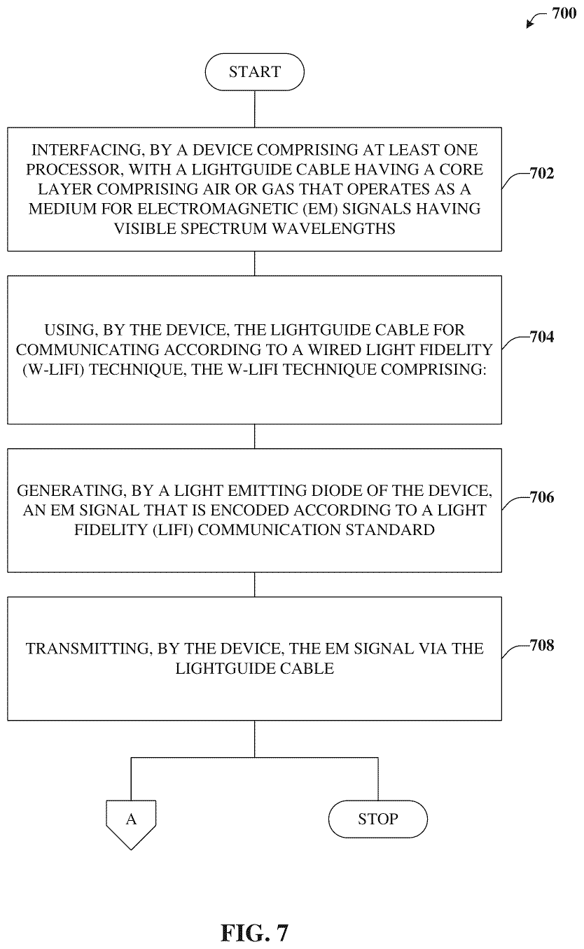

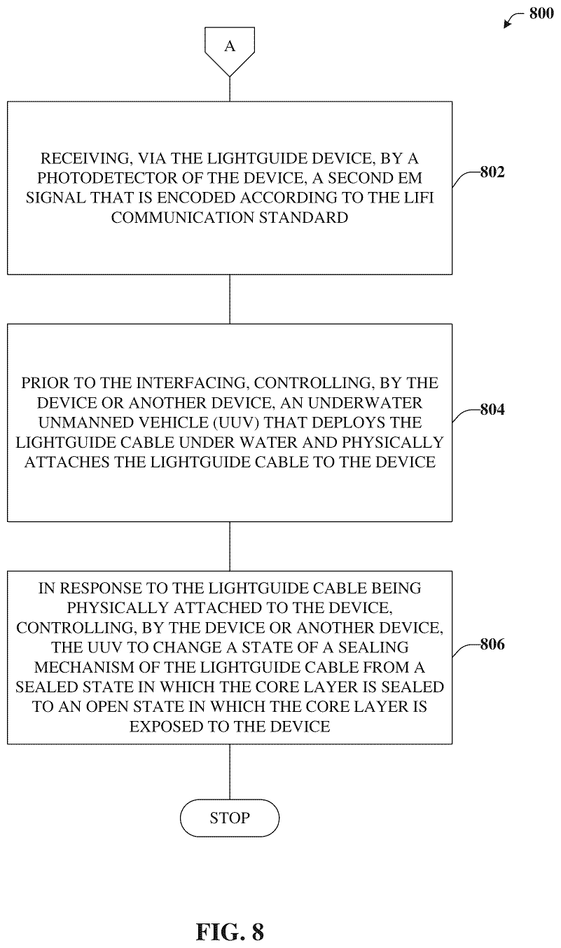

FIGS. 7 and 8 illustrate various example methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, example method 700 is depicted. Method 700 can provide communication between two endpoint devices according to a wired LIFI technique in accordance with certain embodiments of this disclosure. In some embodiments, such communication can be in a submarine or underwater environment. While method 700 describes a complete method, in some embodiments, method 700 can include one or more elements of method 800, reached via insert A, as discussed at FIG. 8.

At reference numeral 702, a device comprising at least one processor can interface with a lightguide cable having a core layer comprising air, which can be indicative of any gas or gas mixture that operates as a medium for EM signals. In some embodiments, the EM signals can have wavelengths in the visible spectrum, which is characterized herein as a wavelength in the range of about 380 nm to about 780 nm.

At reference numeral 704, the device can use the lightguide cable for communicating according to a wired light fidelity (w-LIFI) communication process. In other words, even though LIFI was conceived to be an OTA communication protocol, the ‘air’ medium can be provided by the core layer of the lightguide cable. Thus, the communication is constrained according to wired communication and, beneficially, protected from interference and attenuation effects that can be widespread in an underwater environment.

At reference numeral 706, as part of the w-LIFI communication process of reference numeral 704, the device can generate an EM signal that is encoded according to a LIFI communication standard or protocol. In some embodiments, the EM signal can be generated by an LED device. As indicated, in some embodiments, the LED device can be configured to generate EM signals in the visible spectrum.

At reference numeral 708, as part of the w-LIFI communication process of reference numeral 704, the device can transmit the EM signal via the lightguide cable, hence, wired LIFI. As noted, the w-LIFI communication can be in an underwater environment. For example, all or a portion of the two endpoints (e.g., edge devices, sensing devices, . . . ) or the lightguide cable can be submerged under water, where wireless techniques (e.g., LIFI) face extensive challenges. Method 700 can terminate in some embodiments, or in other embodiments proceed to insert A, which is further detailed in connection with FIG. 8.

Turning now to FIG. 8, example method 800 is depicted. Method 800 can provide for additional elements or functionality relating to communication between two endpoint devices according to a wired LIFI technique in accordance with certain embodiments of this disclosure.

For example, at reference numeral 802, the device introduced in connection with FIG. 7 detailed to generate and transmit the EM signal (e.g., operate as a transmitter) can further be configured to receive, via the lightguide device an EM signal, that is, to operate as a receiver. In that regard, the receiver portion can comprise photodetectors to receive or detect the EM signals propagated by the lightguide device.

At reference numeral 804, prior to the interfacing, e.g., prior to operation, such as during an installation and/or configuration process, the device or another related device can control a UUV that deploys the lightguide cable under water and physically attaches the lightguide cable to the device. It is observed that UUV deployment and installation can be feasible given the lightguide cable can have reduced weight (e.g., a non-solid core), improved durability and/or is not as structurally fragile (e.g., air as opposed to highly refined glass) relative to fiber optic cable.

A reference numeral 806, in response to the lightguide cable being physically attached to the device, the device or the other related device can control the UUV to change a state of a sealing mechanism of the lightguide cable. For example, once connected to one of the two endpoints, the UUV can change the sealing mechanism from a sealed state in which the core layer is sealed to an open state in which the core layer is exposed to the associated endpoint.

### Example Operating Environments

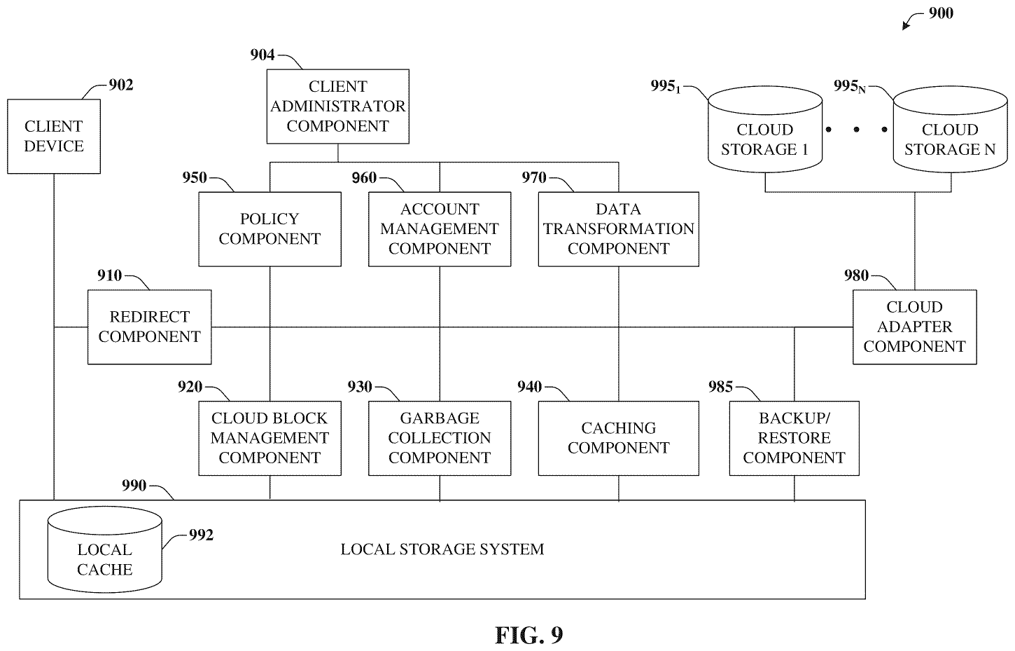

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system, such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details, such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria, such as criteria that area a function of one or more of file name, file path, file size, file attributes including user generated file attributes, last modified time, last access time, last status change, file ownership, etc. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies, such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information, such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal, such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media, such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory, such as ROM, erasable programmable read only memory (EPROM), EEPROM, which BIOS contains the basic routines that help to transfer information between elements within the computer 1002, such as during startup. The RAM 1012 can also include a high-speed RAM, such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures, such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms, such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lightguide device, comprising:
a conduit configured to operate as an underwater transport medium for electromagnetic radiation (EMR) signals, the conduit comprising:
an outer layer comprising a first material that is flexible according to a flexibility criterion, is adapted to resist corrosion when immersed in water with respect to a non-corrosion criterion, and is adapted to withstand a hydrostatic pressure above a defined threshold;
an intermediate cladding layer comprising a second material configured to clad a reflective material to an inner surface of the outer layer; and
a core layer composed of a fluid that operates as a propagation medium for the EMR signals that are propagated from a first end of the conduit through the fluid to a second end of the conduit via interactions with the reflective material.

2. The lightguide device of claim 1, wherein the first material is a composite plastic material.

3. The lightguide device of claim 1, wherein the reflective material is a dielectric mirror coating material.

4. The lightguide device of claim 1, wherein the reflective material comprises a reconfigurable intelligent surface configured to alter at least one of at least one phase or at least one amplitude of at least one EMR signal of the EMR signals.

5. The lightguide device of claim 1, wherein the fluid is air.

6. The lightguide device of claim 1, wherein the conduit further comprises a connector assembly situated at one of, or each of, the first end or the second end, wherein the connector assembly comprises a sealing device that, when open, exposes the core layer and, when closed, seals the core layer, preventing the fluid from escaping the core layer or preventing the water from entering the core layer.

7. The lightguide device of claim 6, wherein the connector assembly comprises a magnet that operates to guide the connector assembly during a mating procedure between the connector assembly of the lightguide device and a corresponding connector for a communication device that uses the lightguide device for communication.

8. The lightguide device of claim 1, wherein the lightguide device is coupled to a communication device that uses the lightguide device for communication, and wherein the communication device is configured to communicate via a light fidelity (LIFI) communication standard, resulting in a wired LIFI (w-LIFI) communication.

9. The lightguide device of claim 8, wherein the communication device that operates according to the w-LIFI comprises a light emitting diode transmitter device that generates a first EMR signal, of the EMR signals, and transmits the first EMR signal via the lightguide device.

10. The lightguide device of claim 8, wherein the communication device that operates according to the w-LIFI comprises a photodetector receiver device that receives a second EMR signal, of the EMR signals, via the lightguide device.

11. A device, comprising:
at least one processor; and
at least one memory that stores executable instructions that, when executed by the at least one processor, facilitate performance of operations, comprising:
interfacing with a lightguide cable having a core layer comprising a fluid that is configured to transport electromagnetic (EM) signals through the lightguide cable; and
utilizing the lightguide cable for communicating according to a wired light fidelity (w-LIFI) communication protocol, comprising:
generating, by a light emitting diode device of the device, an EM signal, of the EM signals, that is encoded according to a light fidelity (LIFI) communication protocol; and
transmitting the EM signal via the lightguide cable.

12. The device of claim 11, wherein the EM signal is a first EM signal, and wherein the w-LIFI communication protocol further comprises reception by a photodetector device, via the lightguide device, a second EM signal that is encoded according to the LIFI communication protocol.

13. The device of claim 11, wherein the EM signal comprises waves of visible light having a wavelength in a range between about 380 nanometers (nm) to about 780 nm.

14. The device of claim 11, wherein the device is an edge device that manages data flows between first network equipment of a first network and second network equipment of a second network.

15. The device of claim 11, wherein at least a portion of the device or the lightguide device is submerged under water, and wherein the lightguide device is coupled to the device by an underwater unmanned vehicle (UUV).

16. The device of claim 15, wherein the lightguide device is coupled to the device via a connector assembly, the connector assembly comprising:
a magnet that operates to guide the connector assembly during a mating performed by the UUV between the connector assembly of the lightguide device and a corresponding connector for the device; and
a sealing device configured for operation by the UUV, wherein the sealing device, when open, exposes the core layer and, when closed, seals the core layer, preventing the fluid from escaping the core layer or preventing water from entering the core layer.

17. A method, comprising:
interfacing, by a device comprising at least one processor, with a lightguide cable having a core layer comprising air or gas that operates as a medium for electromagnetic (EM) signals having visible spectrum wavelengths;
using, by the device, the lightguide cable for communicating according to a wired light fidelity (w-LIFI) communication process, the w-LIFI communication process comprising:
generating, by a light emitting diode of the device, an EM signal that is encoded according to a light fidelity (LIFI) communication standard; and
transmitting, by the device, the EM signal via the lightguide cable.

18. The method of claim 17, wherein the EM signal is a first EM signal, and further comprising, receiving, via the lightguide device by a photodetector of the device, a second EM signal that is encoded according to the LIFI communication standard.

19. The method of claim 17, further comprising, prior to the interfacing, controlling, by the device or via another device, an underwater unmanned vehicle (UUV) that deploys the lightguide cable under water and physically attaches the lightguide cable to the device.

20. The method of claim 19, further comprising, in response to the lightguide cable being physically attached to the device, controlling, by the device or via the other device, the UUV to change a state of a sealing mechanism of the lightguide cable from a sealed state in which the core layer is sealed to an open state in which the core layer is exposed to the device.
